(19) United States
(12) Patent Application Publication
(10) Pub. No.: US 2026/0041284 A1
(43) Pub. Date: Feb. 12, 2026

(54) BLENDER WITH DESCENDING LID FOR STORAGE

(71) Applicant: Hamilton Beach Brands, Inc., Glen Allen, VA (US)

(72) Inventors: Brian Bock, Glen Allen, VA (US); Michael Garman, Glen Allen, VA (US)

(73) Assignee: Hamilton Beach Brands, Inc., Glen Allen, VA (US)

(21) Appl. No.: 19/247,791

(22) Filed: Jun. 24, 2025

Related U.S. Application Data
(60) Provisional application No. 63/680,184, filed on Aug. 7, 2024.

(51) Int. Cl. A47J 43/07; A47J 43/046

(52) U.S. Cl. CPC A47J 43/0727; A47J 43/046

(57) ABSTRACT

A blender includes a jar and a lid configured to at least partially fit within an upper edge of the jar to cover the interior cavity. The lid has a handle that is movable between a first position, in which the handle engages the upper edge of the jar and is prevented from descending further within the interior cavity of the jar, while the sealing member creates a seal with the interior cavity of the jar, and a second position, in which the handle does not engage the upper edge of the jar, thereby permitting the lid to descend further within the interior cavity of the jar, while the sealing member maintains a seal with the interior cavity of the jar.

### RELATED APPLICATION

The present application claims priority from and the benefit of U.S. Provisional Patent Application No. 63/680,184, filed Aug. 7, 2024, the disclosure of which is hereby incorporated herein by reference in full.

### FIELD OF THE INVENTION

This disclosure is directed to small kitchen appliances and more particularly to blenders.

### BACKGROUND

A blender is a household appliance capable of mixing liquids and chopping dry foods. Blenders are also useful for liquefying food items and for blending solids with liquids. A typical blender includes a blender jar assembly comprising a collar and a container that sits on top of a blender base or housing that encloses a motor. The collar includes a blending tool (often a series of blades) rotatably mounted thereto. The blending tool is rotatably engageable with a drive shaft of the motor in an operating configuration. Foodstuff is placed into the container and the blender jar assembly is engaged with the blender base. After the blender jar is covered with a lid, the foodstuff is blended within the volume defined by the blender jar, and the blender jar assembly is removed from the blender base to dispense or pour the blended foodstuff.

Some food items are prone to oxidation once blended, and an improvement to the configuration of a blenders jar may be desirable.

### SUMMARY

As a first aspect, embodiments of the invention are directed to a blender comprising: a base that includes a drive unit; a jar that resides above the base, the jar having an interior cavity; and a lid configured to at least partially fit within an upper edge of the jar to cover the interior cavity. The lid comprises: a foundation; a handle movably mounted to the foundation; and a sealing member mounted to the foundation and extending radially outwardly to engage and seal the interior cavity of the jar. The handle is movable between a first position, in which the handle engages the upper edge of the jar and is prevented from descending further within the interior cavity of the jar, while the sealing member creates a seal with the interior cavity of the jar, and a second position, in which the handle does not engage the upper edge of the jar, thereby permitting the lid to descend further within the interior cavity of the jar, while the sealing member maintains a seal with the interior cavity of the jar.

As a second aspect, embodiments of the invention are directed to a blender comprising: a base that includes a drive unit; a jar that resides above the base, the jar having an interior cavity; and a lid configured to at least partially fit within an upper edge of the jar to cover the interior cavity. The lid comprises: a foundation; a sealing member mounted to the foundation and extending radially outwardly to engage and seal the interior cavity of the jar; an air exhaust port configured such that lowering the lid into the jar causes air in the interior cavity to vent out of the interior cavity through the air exhaust port; and an air intake port configured such that raising the lid within the jar causes air outside the jar to enter the interior cavity through the air intake port.

### BRIEF DESCRIPTION OF THE FIGURES

FIG. 1 is a perspective view of a blender according to embodiments of the invention.

FIG. 2 is a perspective view of the blender jar and lid of the blender of FIG. 1

FIG. 3 is a top perspective view of the blender jar of FIG. 2.

FIG. 4 is a perspective section view of the blender jar of FIG. 2.

FIG. 5 is a top view of the blender jar of FIG. 2.

FIG. 6 is a top perspective view of the lid for the blender jar of FIG. 2.

FIG. 7 is a section view of the lid of FIG. 6.

FIG. 8 is top perspective view of the foundation of the lid of FIG. 6.

FIG. 9 is an opposite top perspective view of the foundation of FIG. 8.

FIG. 10 is a top perspective view of the handle base of the lid of FIG. 6.

FIG. 11 is a side perspective view of the handle base of FIG. 10.

FIG. 12 is a top perspective view of the handle cover of the lid of FIG. 6.

FIG. 13 is a bottom perspective view of the handle cover of the lid of FIG. 6.

FIG. 14 is a side perspective section view of the top cover, the lower disk, the sealing ring, the biasing ring, and the annular cap of the lid of FIG. 6.

FIG. 15 is a top perspective view of the top cover of the lid of FIG. 6.

FIG. 16 is a bottom perspective view of top cover and lower disk of the lid of FIG. 6.

FIG. 17 is a top perspective view of the lower disk of the lid of FIG. 6.

FIG. 18 is a top perspective view of the annular cap of the lid of FIG. 6.

FIG. 19 is a bottom perspective view of the annular cap of FIG. 18.

FIG. 20 is a top perspective view of the biasing ring of the lid of FIG. 6.

FIG. 21 is a bottom perspective view of the biasing ring of FIG. 20.

FIG. 22 is a bottom perspective view of the biasing ring of FIG. 20 with the spring in place.

FIG. 23 is a top view of the blender jar of FIG. 2 with the handle in a first position in which lowering of the lid within the blender jar is prevented.

FIG. 24 is a partial side perspective section view of the lid and blender jar with the handle shown as in FIG. 23.

FIG. 25 is a top section view of the lid and blender jar showing the position of the finger of the biasing ring in the first position of FIG. 23.

FIG. 26 is a top view of the blender jar of FIG. 2 with the handle in a second position in which lowering of the lid within the blender jar is permitted.

FIG. 27 is a partial side perspective section view of the lid and blender jar with the handle shown as in FIG. 26 and with the lid positioned near the lower portion of the blender jar.

FIG. 28 is a top section view of the lid and blender jar showing the position of the finger of the biasing ring in the second position of FIG. 26.

FIG. 29 is a perspective view of a lid according to embodiments of the present invention, with the lid shown in the second position as illustrated in FIG. 26 appropriate for lowering and storage.

FIG. 30 is a perspective view of the lid of FIG. 29 shown in the first position as illustrated in FIG. 23 appropriate for operation of the blender.

FIG. 31 is a top perspective view of the foundation of the lid of FIG. 29.

FIG. 32 is another top perspective view of the foundation of FIG. 31.

FIG. 33 is a section view of the foundation of FIG. 31.

FIG. 34 is a top perspective view of the handle base and handle bridge of the lid of FIG. 29.

FIG. 35 is a top perspective view of the handle bridge of FIG. 34.

FIG. 36 is a top perspective view of the handle base of FIG. 34.

FIG. 37 is a bottom perspective view of the handle base of FIG. 34.

FIG. 38 is a section view of the handle base of FIG. 34.

FIG. 39 is a top perspective view of the cap of the lid of FIG. 29.

FIG. 40 is a bottom perspective view of the cap of FIG. 39.

FIG. 41 is a section view of the lid of FIG. 29 shown in the second position appropriate for lowering and raising of the lid within the blender.

FIG. 42 is a section view of the lid of FIG. 30 shown in the first position appropriate for operating the blender.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

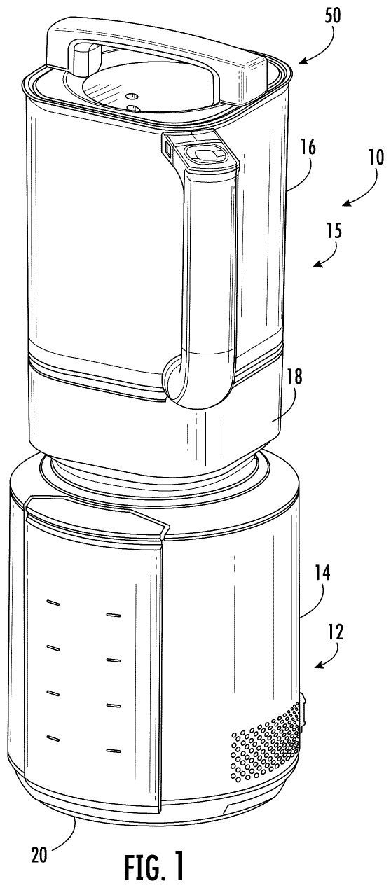

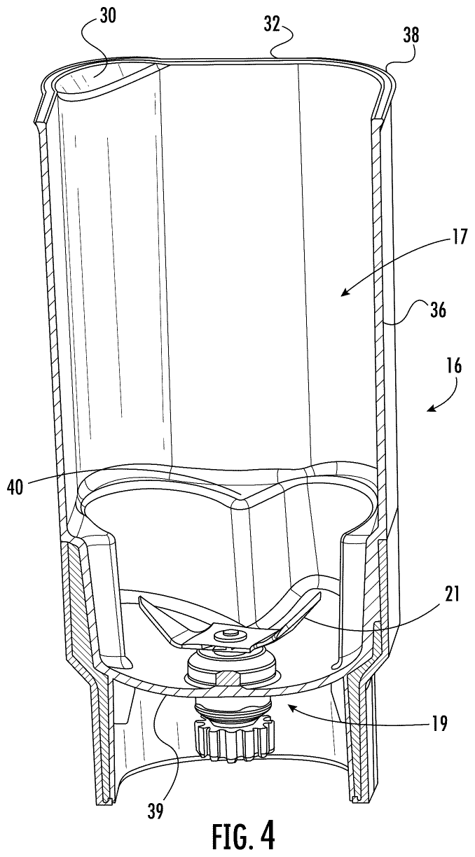

Referring now to the drawings, a blender is shown in FIG. 1 and designated broadly at 10. As can be seen in FIG. 1, the blender 10 includes a base 12 covered with a housing 14 and a blender jar assembly 15 that includes a blender jar 16, a collar 18 that serves as a transition between the base 12 and the blender jar 16, a blending tool unit 19 (see FIG. 4), which typically includes one or more blades 21, and a lid 50.

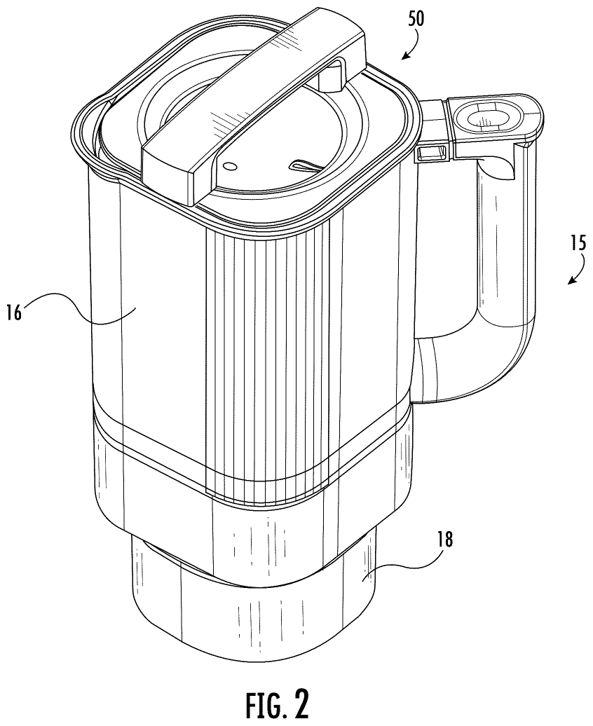

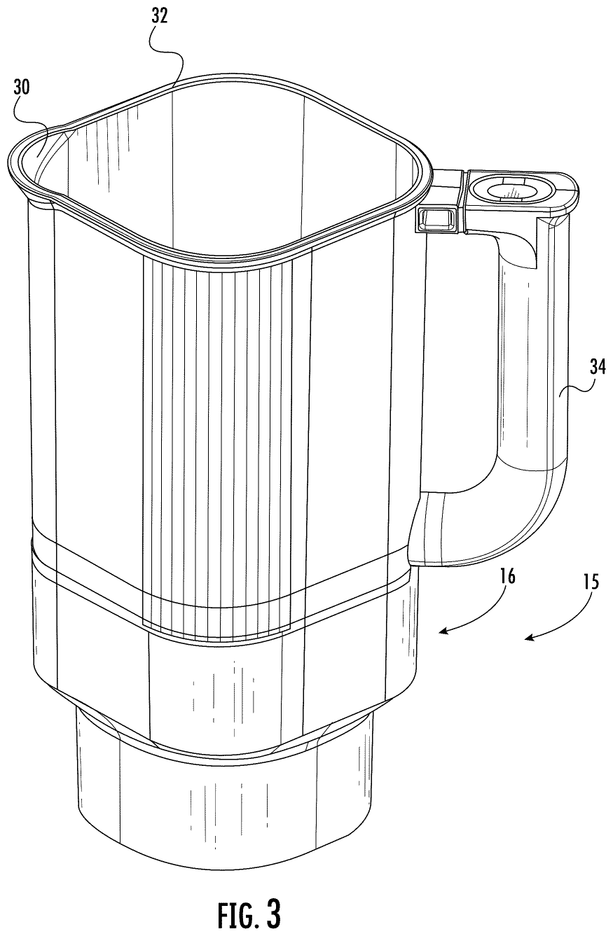

Referring to FIG. 1, the base 12 is shown therein. As shown therein, the housing 14 is generally cylindrical. A control panel 20 is mounted on the side wall of the housing 14. The control panel 20 is operatively connected with a motor or other drive unit (not shown) mounted within the housing. The motor is attached with a fitting that is configured to serve as an interface with the blending tool unit 19 (FIG. 4) of the blender jar assembly 15 to enable it to rotate. Those of skill in this art will appreciate that the base 12 and its components may be of conventional construction and need not be described in detail herein. An exemplary base is discussed in U.S. Pat. No. 7,422,236 and 7,950,842, the disclosure of each of which is hereby incorporated herein by reference in full. The collar 18 is shown in FIGS. 2-4.

Referring now to FIGS. 2-5, the blender jar 16 is of conventional structure (it is an open-ended container with an interior cavity 17) and is typically formed of glass or another glass-like material. The blender jar 16 includes a spout 30 on one side of the upper edge 32 and a handle 34 mounted to the side wall 36 of the blender jar diametrically opposite the spout 30.

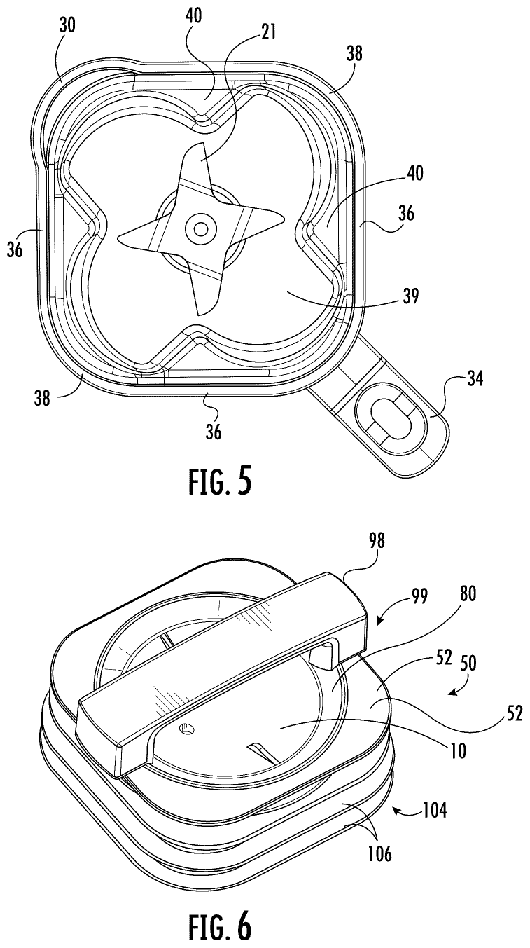

In the illustrated embodiment, the blender jar 16 has a cross-section that can be described as generally square with rounded corners. This arrangement can be seen in the cross-sectional view of FIG. 5, wherein the four side walls 36 meet at four rounded corners 38. It can also be seen that ledges 40 extend inwardly from the side walls 36 and corners 38 and upwardly from the floor 39 in generally a scalloped pattern (see FIGS. 4 and 5)

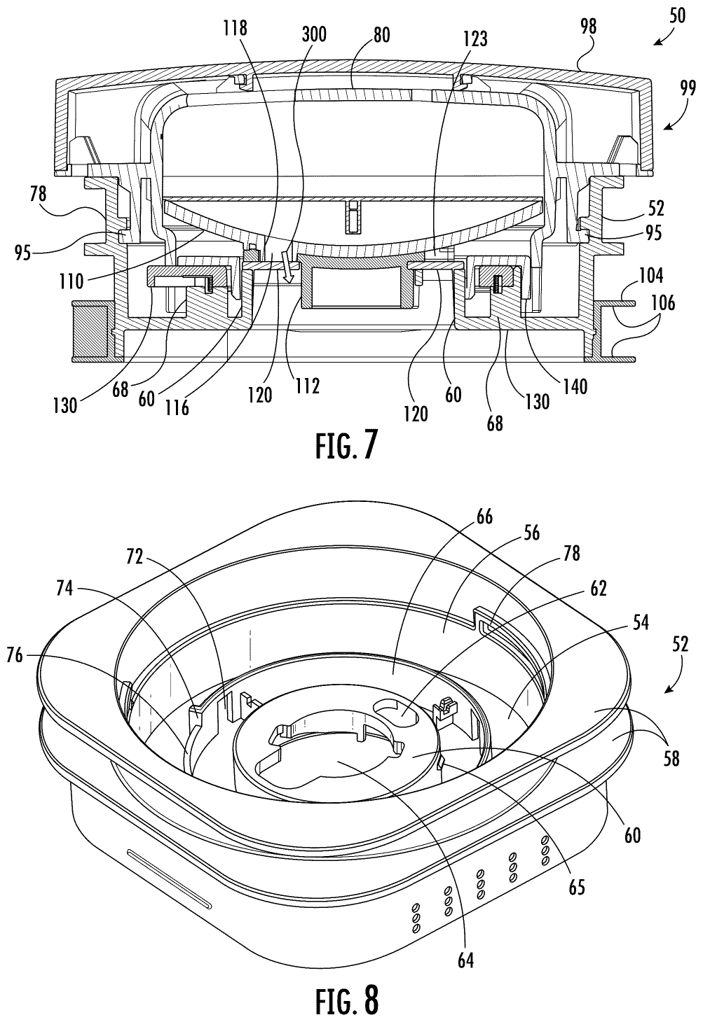

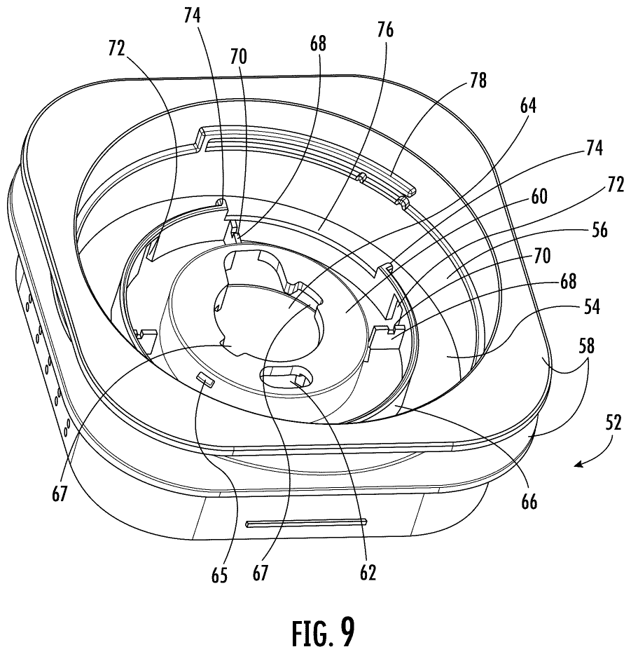

Referring now to FIGS. 6 and 7, the lid 50 is shown therein. The lid 50 includes a foundation 52 (FIGS. 8 and 9) having a floor 54 and cylindrical side walls 56. Two fins 58 extend radially outwardly from the side walls 56 to define generally a square with rounded corners. The foundation 52 includes a pedestal 60 that extends upwardly from the floor 54. The pedestal 60 has a small oblong hole 62 and a much larger irregularly-shaped hole 64 in its upper surface. Three nubs 65 extend radially outwardly from the pedestal 60. A ring 66 surrounds the pedestal 60. Members 68 with open slots 70 extend radially inwardly from the ring 66 toward the pedestal 60. Three slots 72 are also present in the ring 66. Tabs 74 extend radially outwardly from the ring 66 on either side of a recess 76. Diametrically-opposed circumferential guides 78 are present on the inner surfaces of the side walls 56 and extend over an angle of approximately 45 degrees.

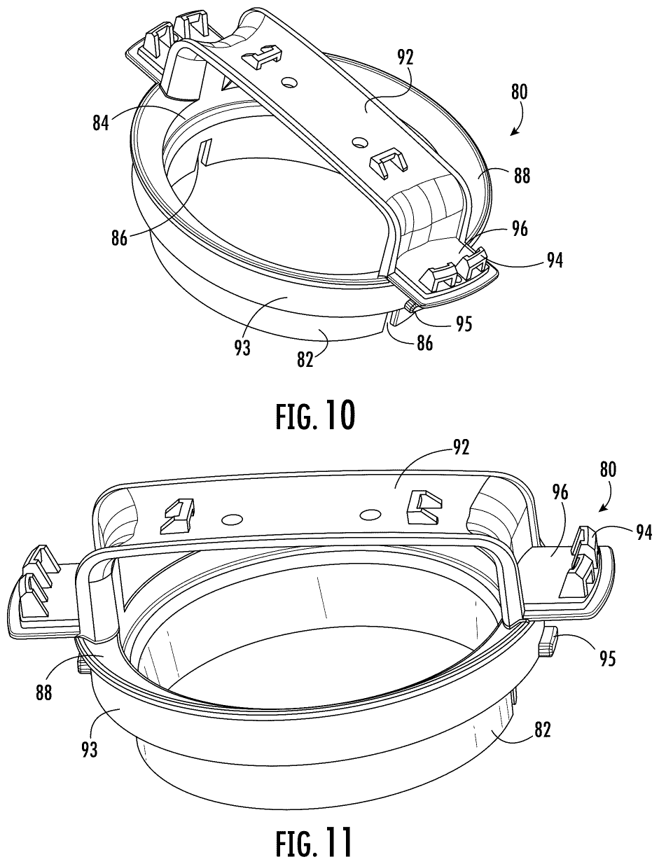

The lid 50 also includes a handle base 80 (FIGS. 10 and 11). The handle base 80 is generally cylindrical, and includes a lower side wall 82 and an upper side wall 84 that is slightly radially outwardly from the lower side wall 82. Two diametrically-opposed open-ended slots 86 are present in the lower side wall 82. An outwardly-extending lip 88 extends from the upper edge of the upper side wall 84. A handle bridge 92 rises from and spans opposite sides of the lip 88. Latches 94 are present on outwardly-extending flanges 96 of the handle bridge 92. U-shaped braces 96 extend upwardly from the upper surface of the handle bridge 92. A ring 93 extends downwardly from the lip 88 radially outwardly of the upper side wall 84. Tabs 95 extend radially outwardly from the lower edge of the ring 93.

The handle base 80 is mounted on the foundation 52 such that the nubs 95 are received in the circumferential guides 78 in the foundation 52 (see FIG. 7). This interaction enables the handle base 80 to rotate over approximately 45 degrees relative to the foundation 52.

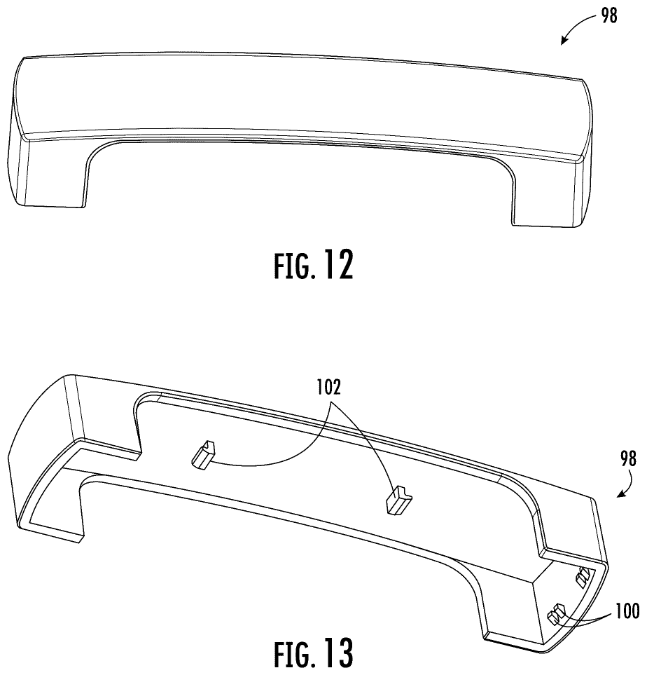

Referring now to FIGS. 12 and 13, a handle cover 98 is configured to overlie and mate with the handle bridge 92. Nubs 100 are present at either end to mate with the latches 94 of the handle bridge 92, and latches 102 are present on the underside of the handle cover 98 to engage the braces 96. Because the handle cover 98 is fixed to the handle base 80, it is free to rotate with the handle base 80. Together the handle cover 98 and handle base 80 form a handle unit 99.

The lid 50 also includes a double seal 104 that surrounds the lower portion of the foundation 52 (see FIGS. 6 and 7). The double seal 104 includes two lips 106 that extend radially outwardly. The outer edges of the lips 106 define generally a square with rounded edges, wherein the square is slightly largely than the inner surface of the blender jar 16. The double seal 104 is typically formed of a resilient elastomeric material, such as rubber or silicone rubber.

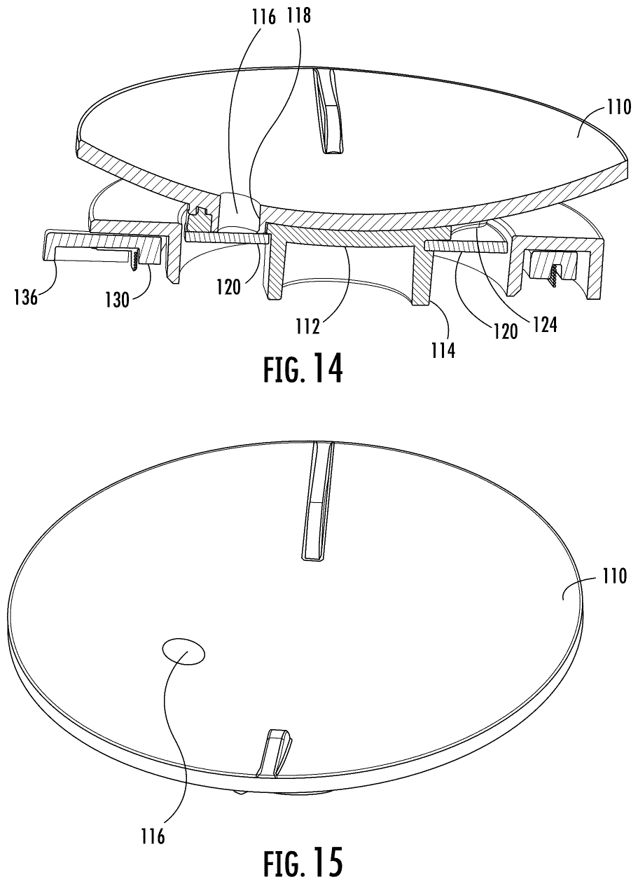

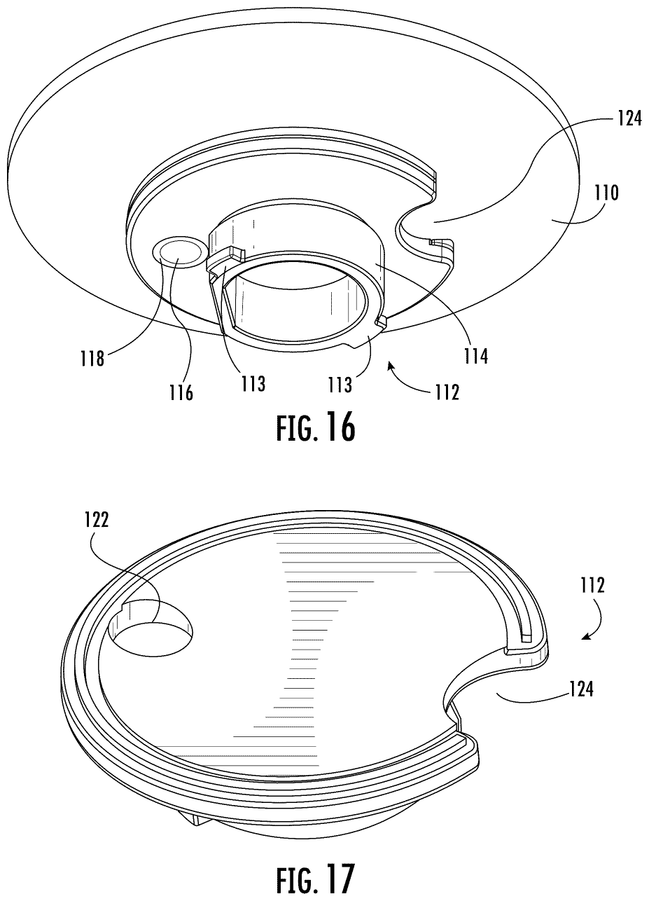

The lid 50 further includes a top cover 110 (FIGS. 14-16) that is round and concave. The top cover 110 is fixed to a lower disk 112 that has a depending skirt 114. The top cover 110 also includes an intake vent 116 with a lower boss 118. The lower disk 112 includes an aperture 122 that receives the lower boss 118, and further includes an aperture 124 diametrically across from the aperture 122 that can function as an exhaust vent 123.

An annular sealing ring 120 (typically formed of a resilient elastomeric material, such as rubber or silicone rubber) encircles the skirt 114 of the lower disk 112 and abuts the lower end of the lower boss 118 of the intake vent 116 (see FIG. 14). The sealing ring 120 also underlies the aperture 124 of the lower disk 112. The sealing ring 120 is supported from underneath by the pedestal 60. As shown in FIG. 7, at atmospheric pressure (i.e., during operation of the blender 10 and at rest), the sealing ring 120 provides a seal against the apertures 122, 124 of the lower disk 112 so that the intake and exhaust vents 116, 123 are sealed.

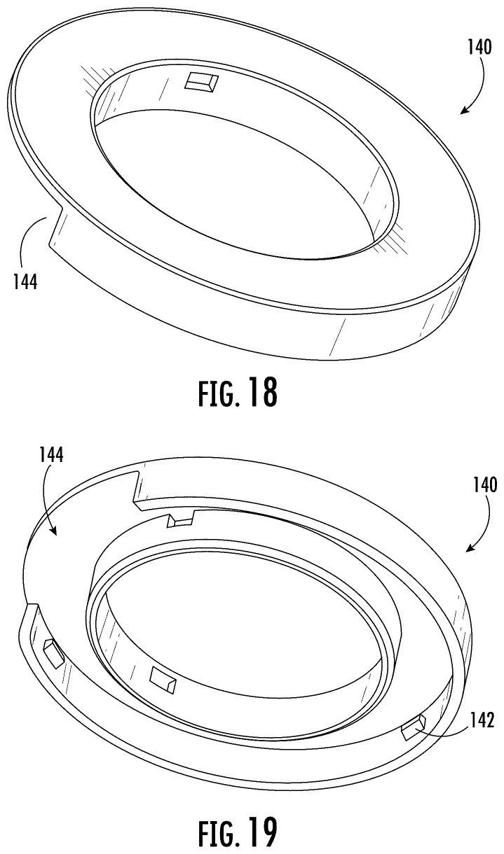

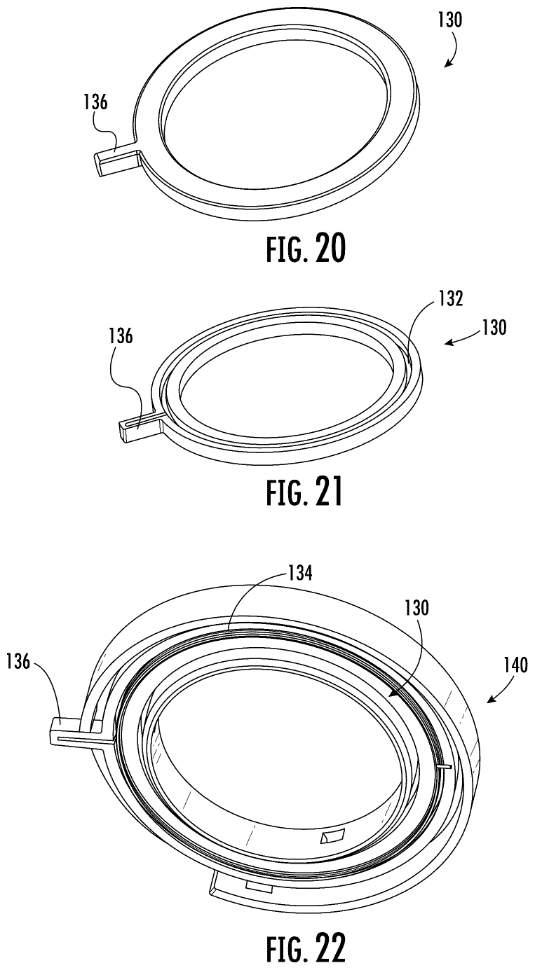

Referring now to FIGS. 7, 18 and 19, an annular biasing ring 130 is positioned between the pedestal 60 and the ring 66 of the foundation 52, and is supported from underneath by the members 68 of the foundation 52. The biasing ring 130 includes a radially-outwardly-extending finger 136 that extends through the recess 76 in the ring 60 and is received in one of the slots 86 of the handle base 80. A groove 132 is present in the lower surface of the biasing ring 130 and receives a helical spring 134. The spring 134 is also received in slots 70 in the members 68 of the foundation 52. An annular cap 140 fits over the biasing ring 130 and is mounted to the foundation 52 via nubs 142 that are received in the slots 72 in the ring 60. The cap 140 includes a recess 144 in its side wall.

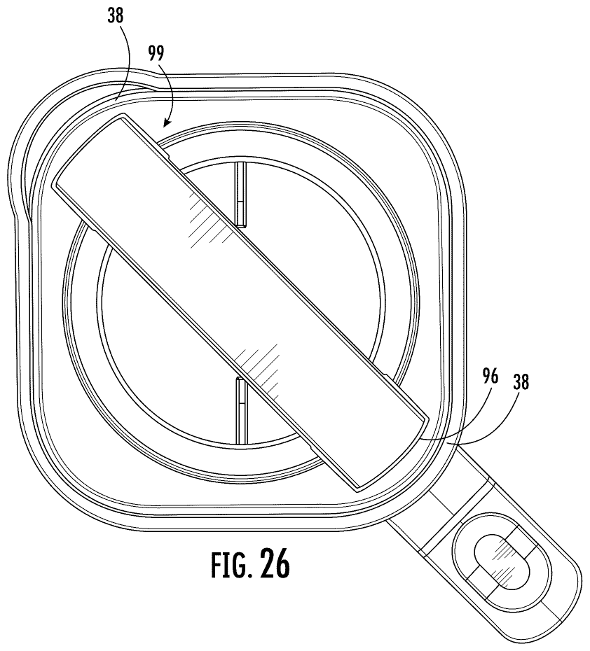

The biasing ring 130 is free to rotate within the annular cap 140 when the handle base 80 and handle cover 98 rotate. The spring 134 engages the biasing ring 130 and the foundation 52 such that rotation is resisted in the counterclockwise direction from the vantage point of FIG. 25. Because the finger 136 of the biasing ring 130 extends through the slot 86 of the lower side wall 82 of the handle base 80, the handle unit 99 is also biased in the clockwise direction.

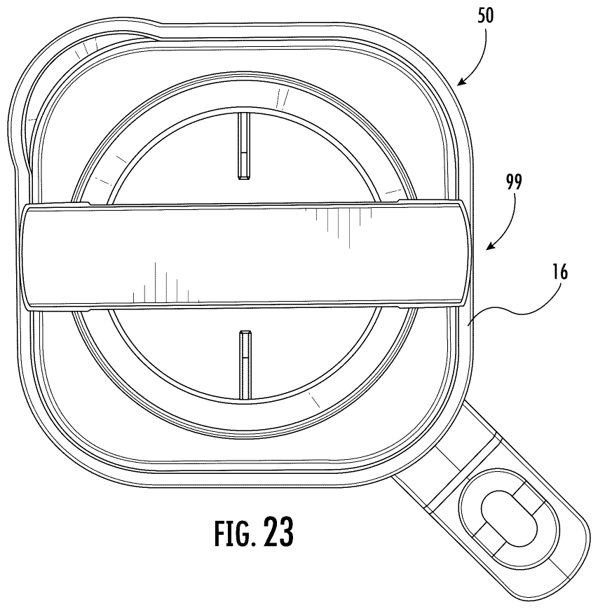

As shown in FIGS. 23-25, the lid 50 can be inserted at least partially into the top of the blender jar 16 to seal the blender jar 16 during use. When so inserted, the lips 106 of the double seal 104 deflect inwardly slightly and therefore form a seal with the inner surface of the blender jar 16.

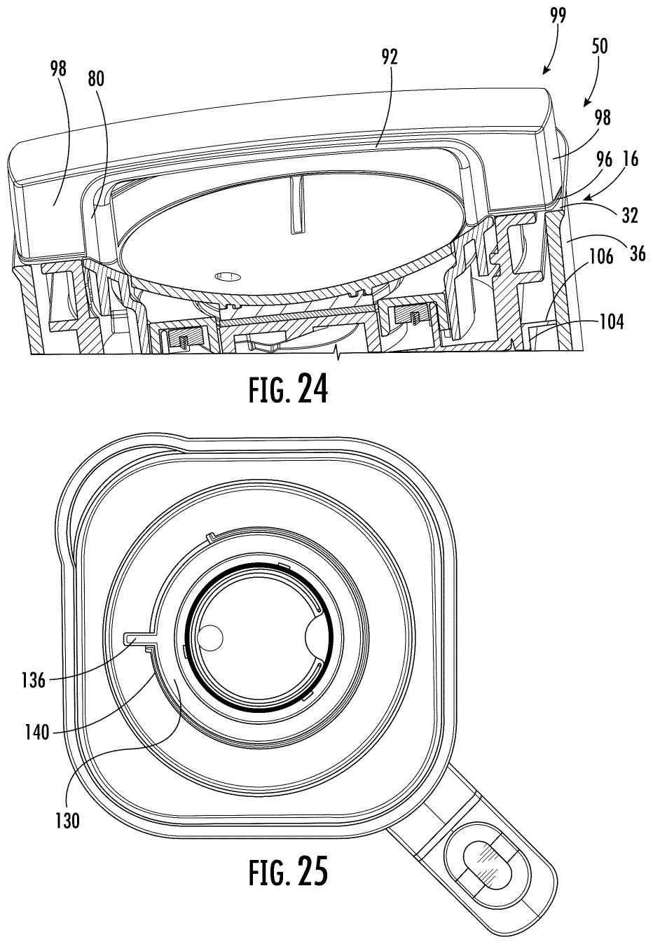

During operation, the handle unit 99 is biased by the spring 134 toward the position shown in FIGS. 23-25. In this position, the handle unit 99 is oriented such that the handle bridge 92 and handle cover 98 extend between opposed side walls 36 of the blender jar 16. It can also be seen in in FIG. 24 that in this position the flanges 96 of the handle base 80 rest atop and directly overlie the upper edges of the blender jar 16, thereby preventing further insertion of the lid 50 into the blender jar during operation for the blender 10.

Once blending is complete, the lid 50 may be removed and the blended contents poured from the blender jar 16 into a receptacle (e.g., a glass or cup) for consumption. However, in some instances, the user may wish to use only a portion of the contents of the jar immediately and store the remainder. The blender 10 shown herein can provide a “vacuum” storage container for the remainder of the contents.

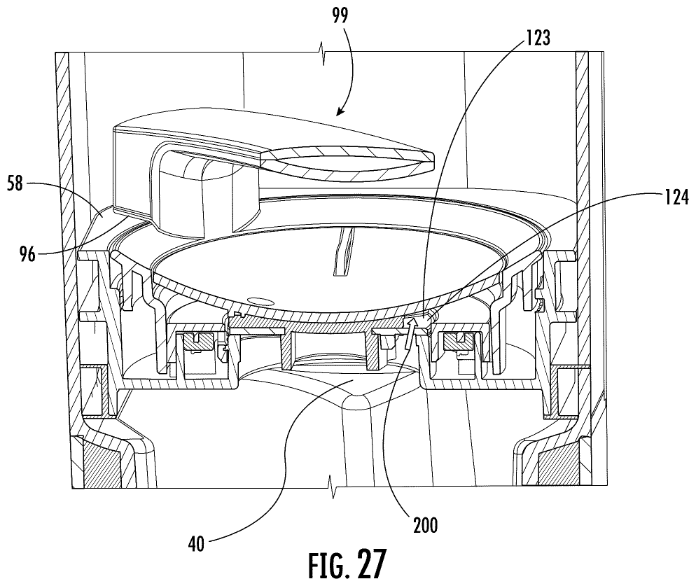

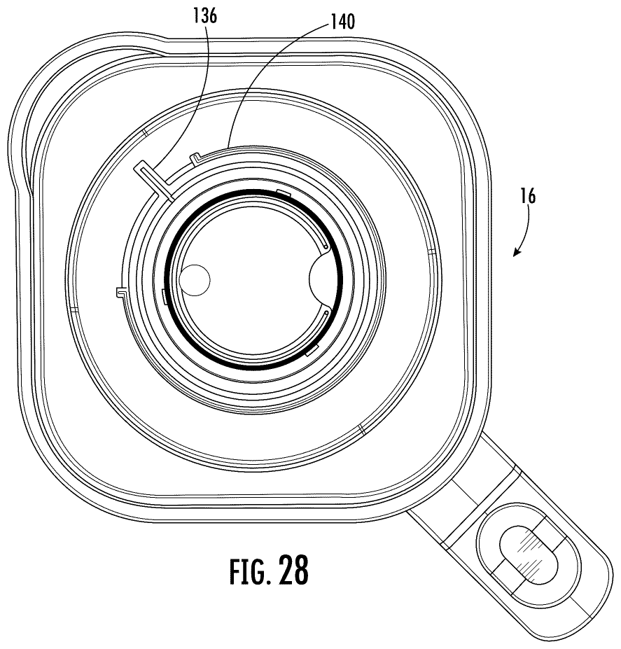

When storage of additional contents is desired, the user first rotates the handle 99 through an angle of approximately 45 degrees (clockwise from the vantage point of FIGS. 23 and 26) so that the handle cover 98 extends between opposed corners 38 of the blender jar 16. (This movement is resisted by the spring 134 biasing the biasing ring 130, and thus the handle unit 99, toward the position of FIG. 24). In the position shown in FIG. 26, it can be seen that the flanges 96 of the handle base 80 no longer overlie the upper edges of the blender jar 16, but instead overlie the fins 58 of the foundation 52. As such, the user can then push downwardly on the lid 50 to force it into the cavity of the blender jar 16. Because the lips 106 of the double seal 104 continue to create a seal with the inner surface of the blender jar 16, air trapped therein increases in pressure. This increase in pressure forces the sealing ring 120 upwardly (as indicated by the arrow 200 in FIG. 27); the presence of the aperture 124 in the lower disk 112 allows the sealing ring 120 to deflect upwardly, thereby allowing air to escape from the blender jar cavity 17 through the exhaust vent 123. Air continues to vent through the aperture 124 as the user lowers the lid 50, with the result that less air is present with the remaining contents of the blender jar 16 to cause spoilage. Once the user ceases lowering the lid 50, the sealing ring 120 recovers to its original position to seal against the pedestal 60 and close the exhaust vent 123. Thus, the blender jar 16 can provide a “vacuum-sealed” environment in which to store the remainder of the contents.

Notably, the lid 50 is prevented from further lowered movement by the ledges 40 in the blender jar 16. The ledges 40 are of sufficient height that the blades of the blending tool unit 19 are protected from the lowered lid 50.

When the user wishes to access the stored contents, the user grasps the handle 99 and lifts the lid 50 within the cavity 17 of the blender jar 16. Because the lid 50 remains sealed with the blender jar 16 via the lips 106 of the double seal 104, lifting the lid 50 tends to create a vacuum within the cavity. This vacuum generates downward pressure on the sealing ring 120, with the result that the sealing ring deflects downwardly and away from the lower boss 118 (see arrow 300 in FIG. 7). As a result, external air can flow through the intake vent 116 in the lower boss 118 into the cavity 17, which can eliminate or reduce the vacuum effect within the cavity and allow the lid 50 to be more easily raised upwardly and out of the blender jar 16.

When the lid 50 is removed from the cavity, the spring 134 forces the handle unit 99 to rotate back to the position of FIG. 24, wherein the handle bridge 92 extends between the sides of the foundation 52 rather than between the corners.

In addition, the lid 50 is constructed so that it can be easily disassembled for cleaning. More specifically, the handle 99 (comprising the handle base 80 and the handle cover 98) can be rotated relative to the foundation 52 (clockwise from the vantage point of FIG. 26) so that the tabs 95 of the handle base 80 escape the open ends of the guides 78. This movement disengages the handle 99 from the foundation 52 and permits the handle 99 to be lifted off of the foundation 52. In addition, the top cover 110, lower disk 112 and sealing ring 120 can be rotated relative to the foundation so that tabs 113 on the skirt 114 are moved to align with cutouts 67 in the irregularly shaped hole 64 of the foundation 52; once the tabs 113 are aligned with the cutouts 67, the top cover 110, lower disk 112 and sealing ring 120 can be lifted as a unit from the foundation 52. The handle 99, the unit including the top cover 110, the lower disk 112, and the sealing ring 120, and the remaining assembled parts can be washed as three separate pieces.

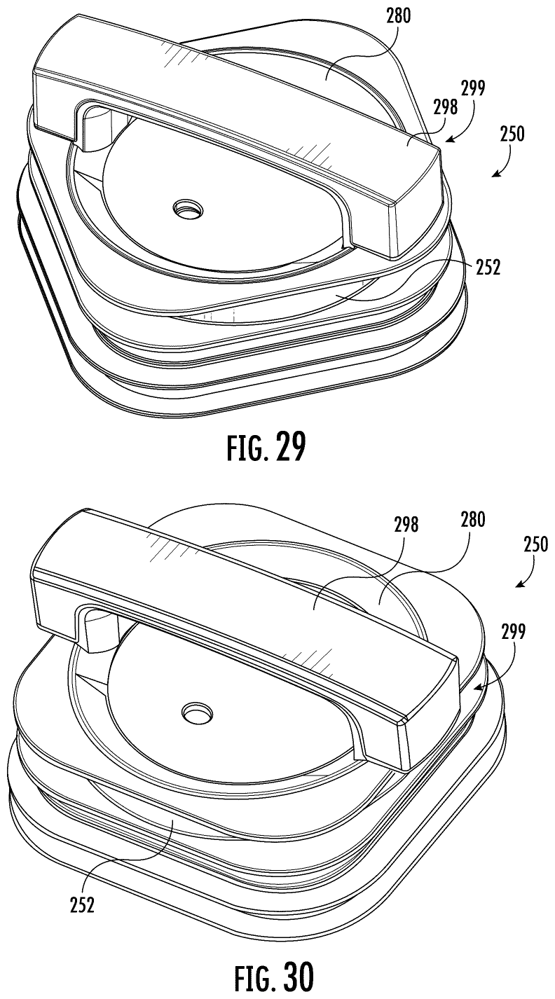

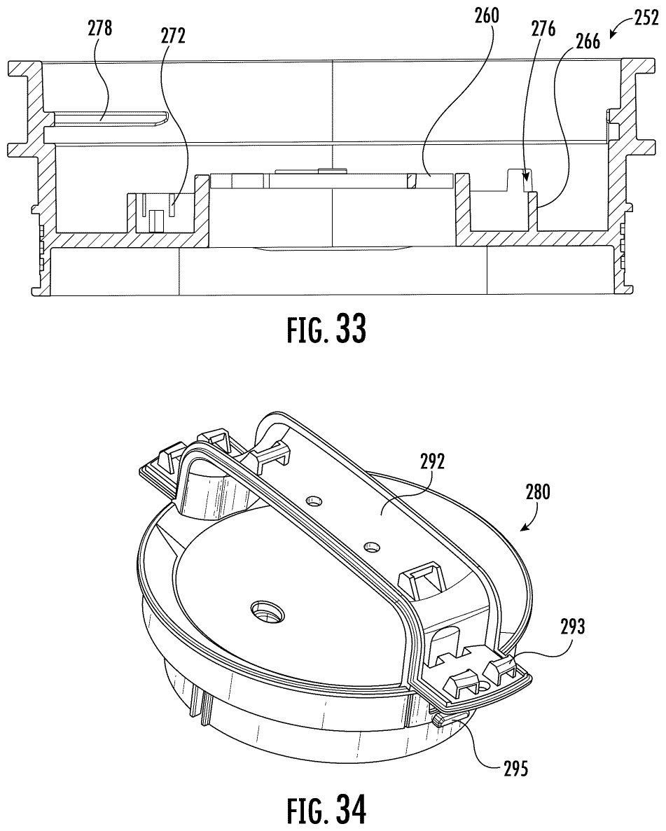

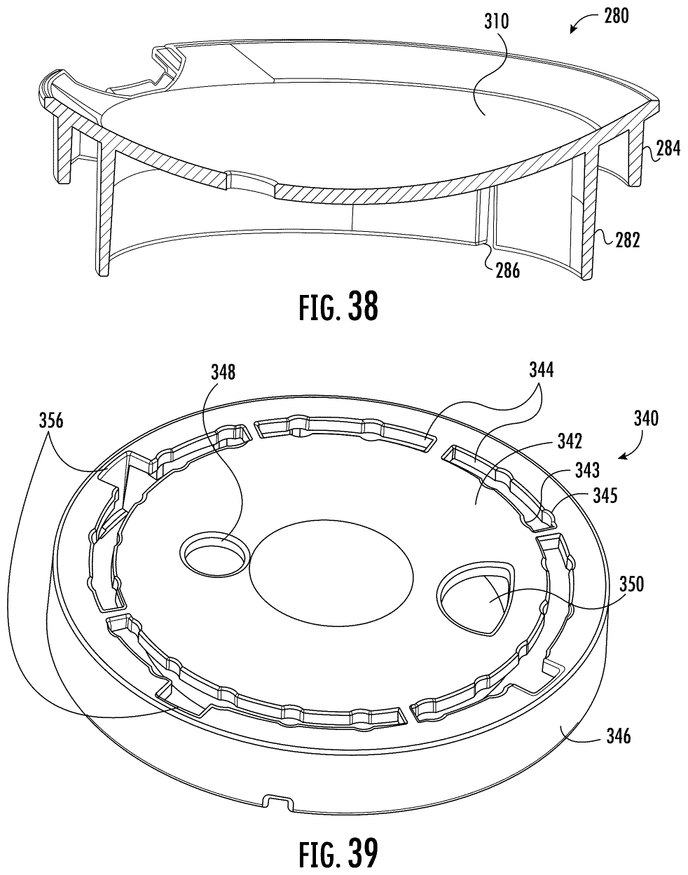

Referring now to FIGS. 29-42, another lid, designated broadly at 250, is shown therein. The lid 250 may be used with a blender 10 in much the same manner as that described above. The lid 250 shares much of the structure of the lid 50, and operates in a largely similar manner, but is constructed differently. The differences in the lid 250 are discussed below.

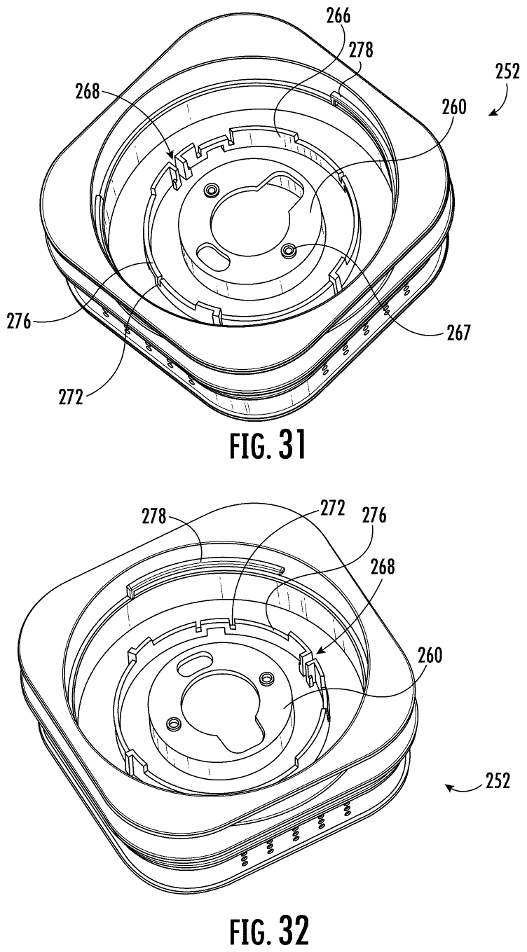

Referring now to FIGS. 31-33, the lid 250 includes a foundation 252. The foundation 252 is similar to the foundation 52, with one exception being that the pedestal 260 of the foundation 252 includes holes 267 rather than cutouts 67. Also, the ring 266 of the foundation 252 includes different features than the ring 66. Specifically, the ring 266 has multiple recesses 276, each of which includes slots 272. Also, a gap 268 is present in the ring 266. Like the foundation 52, the foundation 252 includes circumferential guides 278.

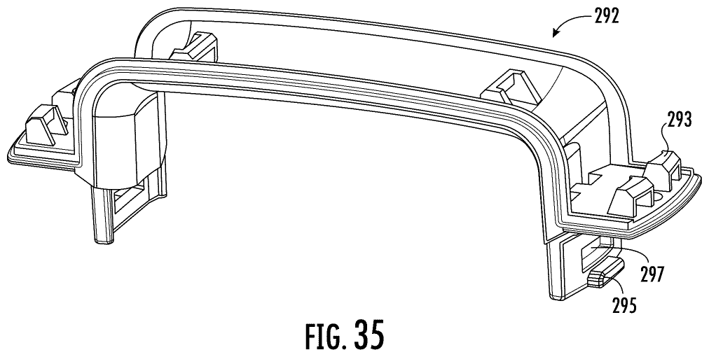

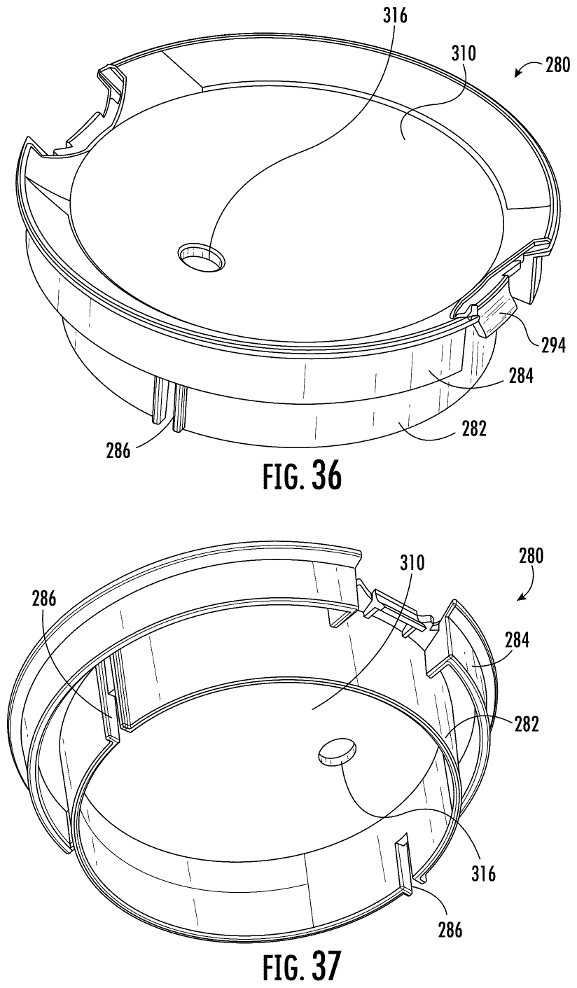

Referring now to FIGS. 34-38, the lid 250 also includes a handle base 280 that is a separate piece from the handle bridge 292. The handle bridge 292 (FIG. 35) includes slots 297 that enable it to be attached to mating features 294 on the handle base 280 (FIG. 36). A handle cover 298 (see FIG. 29) is configured to overlie and attach to the handle bridge 292 via features 293 to form a handle unit 299. The handle bridge 292 also includes a nub 295 on its radially outward surface.

The handle base 280 includes an upper side wall 284 and a lower side wall 282 that is radially inward of the upper side wall 284. Diametrically-opposed slots 286 are present in the lower side wall 284.

The top cover 310 is integrated with the handle base 280. There is no structure analogous to the lower disk 112 of the top cover 110. The top cover 310 includes a vent 316.

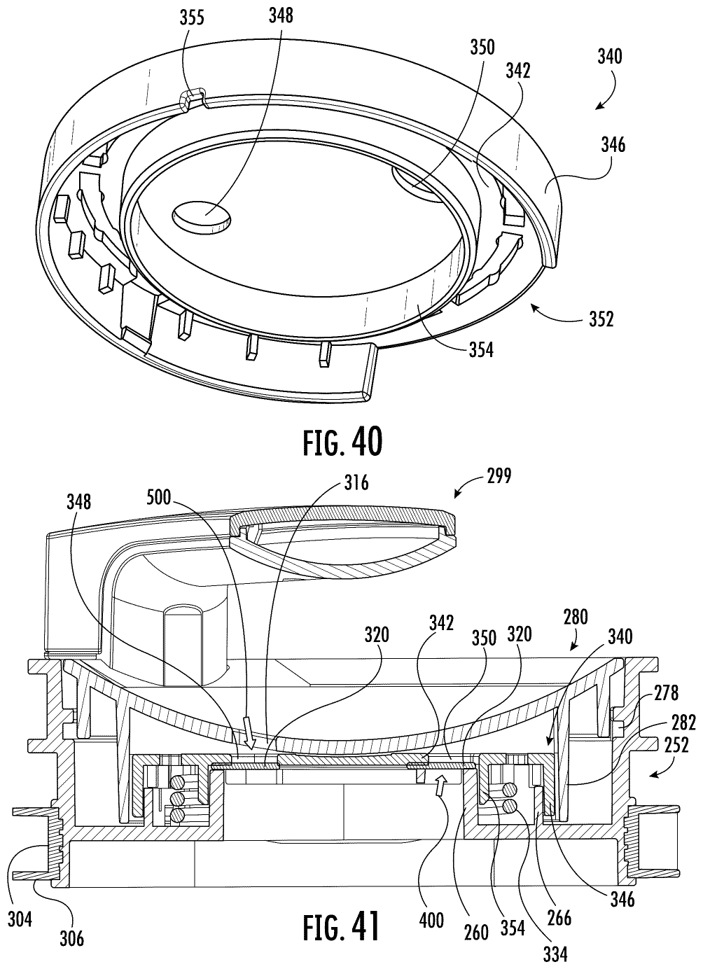

A circular cap 340 (FIGS. 39 and 40) includes an upper surface 342 that has a series of discontinuous arcuate slots 344. Each of the slots 344 has both radially-inward and radially-outward detents 343, 345. Vent holes 348, 350 are present in the upper surface 342, with the vent hole 348 being radially inward of and slightly smaller than the vent hole 350. The rim 346 has a recess 352 of approximately 90 degrees. An inner ring 354 depends from the upper surface 342 radially inward of the slots 344 but radially outward of the vent holes 348, 350. Cutouts 356 extend radially outwardly from three of the slots 344 and are spaced approximately 90 degrees apart.

An annular sealing ring 320 overlies a portion of the upper surface 342 and the vent holes 348, 350 (FIG. 41). A helical spring 334 is positioned between the rim 346 and the inner ring 354.

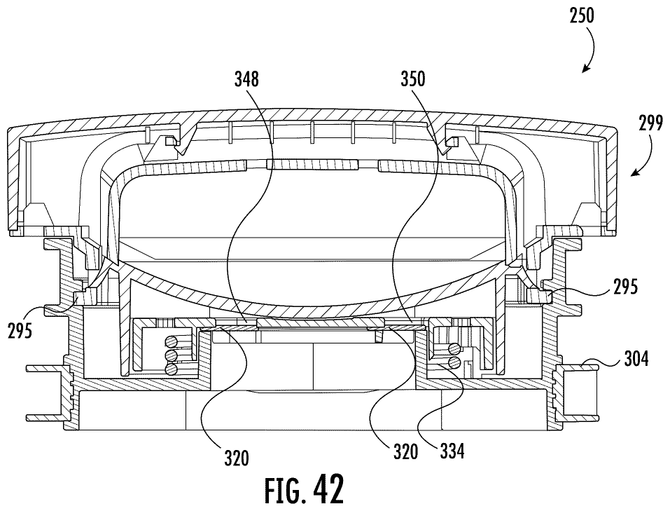

As shown in FIGS. 41 and 42, when the lid 250 is assembled, the cap 340 intermeshes with the foundation 252, with the inner ring 354 positioned between the ring 266 and the pedestal 260, and with the rim 346 positioned radially outwardly of the ring 266. The spring 334 is located between the inner ring 354 and the ring 266. One end of the spring 334 extends through a recess 355 in the outer ring 346 and into the slot 268; the other end of the spring extends through the recess 352 and into another of the slots 286. This arrangement enables the cap 340 and the handle base 280 to rotate together relative to the foundation 252. One end of the spring 334 also extends through the gap 268 in the ring 266. The sealing ring 320 is sandwiched between the upper surface 342 of the cap 340 and the pedestal 260 of the foundation 252. The handle base 280 is positioned so that the lower side wall 282 is radially outward of the rim 346 of the cap 340. The nubs 295 on the handle bridge 292 fit within the circumferential guides 278.

Operation of the lid 250 is much like that of the lid 50. When the blender 10 is in operation, the handle unit 299 of the lid 250 is oriented so that it extends between opposing side walls of the blender 10 (see FIG. 42), and therefore cannot be moved into the cavity of the blender 10. The lips of the double seal 304 meet the inner surfaces of the side walls of the blender 10 to provide a seal. Also, the sealing ring 320 provides seals against the vent holes 348, 350. The spring 334 biases the handle base 280 and the cap 340 toward this position.

When the user wishes to seal in some remaining portion of the foodstuff in the blender 10 for storage, the user rotates the handle unit 299 so that the handle unit 299 extends between opposite corners of the blender 10 (FIG. 41). This movement also rotates the handle base 280 and the cap 340 relative to the foundation 252, with the rotation being guided by movement of the nubs 295 within the guides 278. As the user presses on and lowers the lid 250 into the blender 10, pressure builds within the cavity of the blender 10. This increase in pressure forces the sealing ring 320 upwardly (as indicated by the arrow 400 in FIG. 41); the presence of the vent hole 350 in the cap 340 allows the sealing ring 320 to deflect upwardly (in particular, the radially-outward edge of the sealing ring 320 can deflect into the vent hole 350), thereby allowing air to exhaust from the blender jar cavity through the vent hole 350, which acts as an air exhaust port. Air continues to vent through the vent hole 350 as the user lowers the lid 250, with the result that less air is present with the remaining contents of the blender jar 16 to cause spoilage. Once the user ceases lowering the lid 250, the sealing ring 320 recovers to its original position to seal against the pedestal 260 and close the vent hole 350. Thus, the blender jar can provide a “vacuum-sealed” environment in which to store the remainder of the contents.

Notably, because both the inner and outer edges of the sealing ring are supported from above by the portion of the cap 340 that surrounds the vent hole 348, the sealing ring 320 does not deflect upwardly under the increased pressure and continues to seal the vent hole 348.

When the user wishes to remove the lid to access the stored foodstuff in the blender 10, the user pulls upwardly on the handle unit 299. Because the lid 250 remains sealed with the blender jar 16 via the lips 306 of the double seal 304, lifting the lid 250 tends to create a vacuum within the cavity. This vacuum generates downward pressure on the sealing ring 320, with the result that the inner edge of the sealing ring 320 (which is not supported from underneath) deflects downwardly and away from the vent hole 348 (see arrow 500 in FIG. 41). As a result, external air can flow through the vent 316 and the vent hole 348 into the cavity 17; they act as an air intake port, which can eliminate or reduce the vacuum effect within the cavity and allow the lid 250 to be more easily raised upwardly and out of the blender jar 16. Because the portion of the sealing ring 320 that underlies the vent hole 350 is supported from beneath at both its inner and outer edges, this portion of the sealing ring 320 does not deflect under the vacuum, with the result that the vent hole 350 remains sealed.

Also, like the lid 50, when the lid 250 is removed from the blender jar, the spring 334 forces the handle unit 299 to return to the position of FIG. 42.

Those of skill in this art will appreciate that the lid may take different forms. For example, in some embodiments the handle may not rotate, but instead have a telescoping configuration that enables the handle to rest atop the upper edge of the jar during operation but to “clear” the upper edges of the jar when the lid is lowered to provide storage for foodstuffs still in the jar. Such a configuration might be employed if the jar has a round cross-section rather than the “rounded square” cross-section shown herein. As another example, if the jar were of an oval cross-section, a handle as illustrated and described herein may be suitable, but rotation of the handle between the first and second positions may require 90 degrees (from the short axis of the oval to the long axis).

In addition, the intake and exhaust vents may also be configured differently. As one example, rather than a single sealing ring being employed for both vents, individual gaskets or seals may be used to create releasable seals. In some embodiments, either the intake or the exhaust port may be omitted. Other variations may also be employed.

Further, the double seals 104, 304 may take a different form; e.g., a sealing member having a single lip 106, 306 may be employed.

Those of skill in this art will further appreciate that the blender may take other forms. For example, the base may take a different form, have different speed and blending options, etc. Different styles, sizes, and shapes of blender jars may be used.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention.

That which is claimed is:

1. A blender, comprising:
a base that includes a drive unit;
a jar that resides above the base, the jar having an interior cavity; and
a lid configured to at least partially fit within an upper edge of the jar to cover the interior cavity, the lid comprising:
a foundation;
a handle movably mounted to the foundation; and
a sealing member mounted to the foundation and extending radially outwardly to engage and seal the interior cavity of the jar;
wherein the handle is movable between a first position, in which the handle engages the upper edge of the jar and is prevented from descending further within the interior cavity of the jar, while the sealing member creates a seal with the interior cavity of the jar, and a second position, in which the handle does not engage the upper edge of the jar, thereby permitting the lid to descend further within the interior cavity of the jar, while the sealing member maintains a seal with the interior cavity of the jar.

2. The blender defined in claim 1, wherein the handle is rotatably mounted to the foundation, and wherein the handle rotates relative to the foundation in moving between the first and second positions.

3. The blender defined in claim 2, wherein the jar has a generally square cross-section with rounded corners.

4. The blender defined in claim 2, wherein the lid further comprises a biasing unit that biases the handle toward the first position.

5. The blender defined in claim 1, wherein the lid further comprises an air exhaust port, such that lowering the lid into the jar causes air in the interior cavity to vent out of the interior cavity through the air exhaust port.

6. The blender defined in claim 1, wherein the lid further comprises an air intake port, such that raising the lid within the jar causes air outside the jar to enter the interior cavity through the air intake port.

7. The blender defined in claim 1, wherein the jar includes a floor and a blending tool unit extending upwardly from the floor.

8. The blender defined in claim 1, wherein the jar includes ribs that extend upwardly from the floor higher than the blending tool unit.

9. The blender defined in claim 1, wherein in the first position, the handle directly overlies the upper edge of the jar, and in the second position, the handle does not directly overlie the upper edge of the jar.

10. A blender, comprising:
a base that includes a drive unit;
a jar that resides above the base, the jar having an interior cavity;
a lid configured to at least partially fit within an upper edge of the jar to cover the interior cavity, the lid comprising:
a foundation;
a sealing member mounted to the foundation and extending radially outwardly to engage and seal the interior cavity of the jar;
an air exhaust port configured such that lowering the lid into the jar causes air in the interior cavity to vent out of the interior cavity through the air exhaust port; and
an air intake port configured such that raising the lid within the jar causes air outside the jar to enter the interior cavity through the air intake port.

11. The blender defined in claim 10, wherein the lid includes a flexible sealing ring, and wherein the sealing ring selectively seals the air exhaust port and the air intake port.

12. The blender defined in claim 10, wherein the lid includes a handle, and wherein the handle is movable between a first position, in which the handle engages the upper edge of the jar and is prevented from descending further within the interior cavity of the jar, while the sealing member creates a seal with the interior cavity of the jar, and a second position, in which the handle does not engage the upper edge of the jar, thereby permitting the lid to descend further within the interior cavity of the jar, while the sealing member maintains a seal with the interior cavity of the jar.

13. The blender defined in claim 12, wherein the handle is rotatably mounted to the foundation, and wherein the handle rotates relative to the foundation in moving between the first and second positions.

14. The blender defined in claim 13, wherein the jar has a generally square cross-section with rounded corners.

15. The blender defined in claim 13, wherein in the first position, the handle directly overlies the upper edge of the jar, and in the second position, the handle does not directly overlie the upper edge of the jar.

16. The blender defined in claim 13, wherein the lid further comprises a biasing unit that biases the handle toward the first position.

17. The blender defined in claim 10, wherein the jar includes a floor and a blending tool unit extending upwardly from the floor.

18. The blender defined in claim 10, wherein the jar includes ribs that extend upwardly from the floor higher than the blending tool unit.
